(19) United States
(12) Patent Application Publication
(10) Pub. No.: US 2007/0083775 A1
(43) Pub. Date: Apr. 12, 2007

(54) Method for suspending execution of preset sleep mode in digital multimedia broadcasting terminal

(75) Inventor: Young-Kyu Seon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/324,242

(22) Filed: Jan. 4, 2006

(30) Foreign Application Priority Data
Oct. 10, 2005 (KR) 2005-94724

(51) Int. Cl. G06F 1/00

(52) U.S. Cl. 713/300

(57) ABSTRACT

A method includes presetting a sleep mode of a digital multimedia broadcasting (DMB) terminal in response to a timing input from a user as to when the sleep mode is to be executed and detecting the arrival of the sleep mode execution time. After detecting the arrival of the sleep mode execution time, it is determined whether a predetermined function relating to a DMB service is being executed. The execution of the sleep mode is suspended until the predetermined function is completed and performed after the completion of the predetermined function.

### PRIORITY

This application claims priority to an application filed in the Korean Intellectual Property Office on Oct. 10, 2005 and assigned Serial No. 2005-94724, the contents of which are incorporated herein by reference.

### BACKGROUND OF THE INVENTION

1. Field of the Invention

The present invention relates to a digital multimedia broadcasting (DMB) terminal, and more particularly to a method for suspending an execution of a preset sleep mode in a digital multimedia broadcasting device such that the sleep mode can be executed according to the execution status of other predetermined functions even though a preset sleep mode execution time arrives.

2. Description of the Related Art

The conventional television (TV) for providing a broadcasting service often support a sleep mode reservation function such that broadcasting can be automatically terminated when a preset sleep mode execution time arrives. Thus, the user presets a desired sleep mode execution time such that a TV can be automatically turned off at the preset sleep mode execution time. Hereinafter, the description about the sleep mode reservation function will be given with reference to FIG. 1. FIG. 1 is a block diagram illustrating the internal structure of the conventional TV.

As shown in FIG. 1, the conventional TV includes a main power module 100 for supplying power to a TV module 120, a switch module 110 for cutting off the power supplied to the TV module 120 and supplying power to the TV module 120, the TV module 120 for performing operations according to the provision of a broadcasting service, and a sleep reservation control module 130 for performing a sleep mode reservation function.

Hereinafter, a procedure of presetting the sleep mode and executing the sleep mode in the TV having the above construction will be described with reference to FIG. 2. FIG. 2 is a flowchart illustrating the procedure of presetting and executing the sleep mode in the conventional TV.

A conventional TV may display a broadcasting screen image through the TV module 120 and additionally support a sleep mode reservation function. If a user selects the sleep mode reservation function, the TV module 120 receives and sets a desired sleep time in step 200. In step 210, a timer counts time while being driven. Sequentially, the sleep reservation control module 130 determines if the preset sleep mode execution time arrives in step 220. If it is determined that the preset sleep mode execution time arrives, the sleep reservation control module 130 may terminate all operations in execution and turn off the TV in step 230. In other words, the sleep reservation control module 130 may cut off power supplied to the TV module 120 from the main power module 100 by controlling the switch module 110. As described above, with the conventional sleep mode reservation function, the TV may be simply turned off.

Recently, a mobile device supports a user with various services such as a digital multimedia broadcasting service in addition to a typical telecommunication service. Accordingly, when the sleep mode reservation function is applied to the mobile terminal, other predetermined functions may be reset by turning off, without discretion, the power of the mobile terminal at a preset sleep mode execution time. Therefore, it is desired to have a method for executing the sleep mode reservation function while giving consideration to the execution status of other various functions.

### SUMMARY OF THE INVENTION

A method includes presetting a sleep mode of a digital multimedia broadcasting (DMB) terminal in response to a timing input from a user as to when the sleep mode is to be executed and detecting the arrival of the sleep mode execution time. After detecting the arrival of the sleep mode execution time, it is determined whether a predetermined function relating to a DMB service is being executed. The execution of the sleep mode is suspended until the predetermined function is completed and performed after the completion of the predetermined function.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an internal structure of a conventional TV;

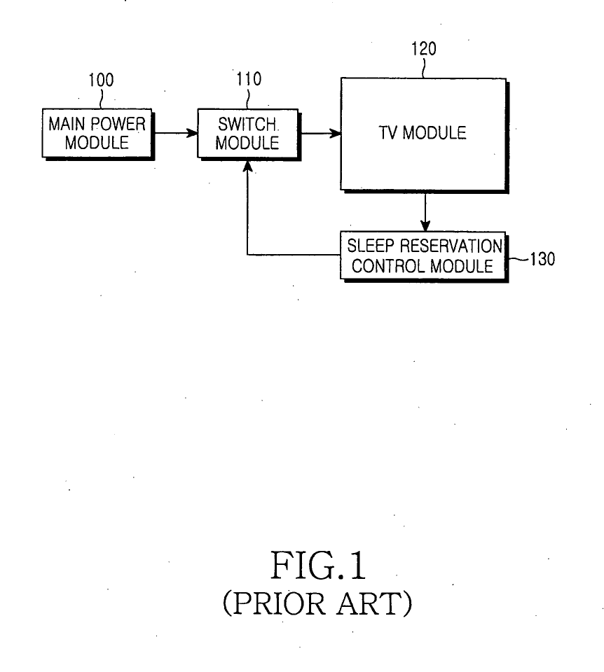

FIG. 2 is a flowchart illustrating a conventional procedure of performing a sleep mode reservation function in a conventional TV;

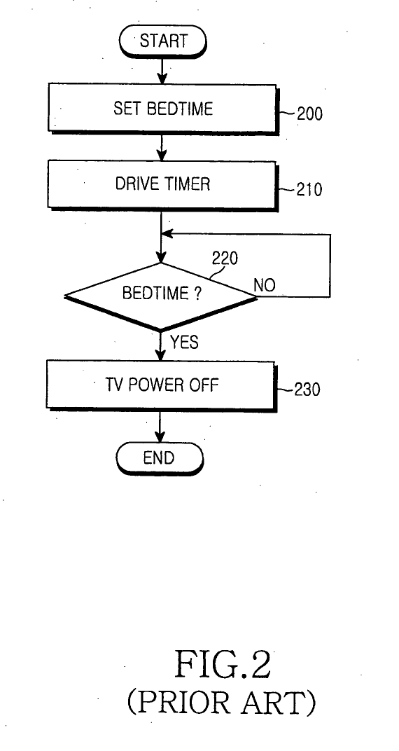

FIG. 3 is a block diagram illustrating an internal structure of a DMB terminal capable of suspending the execution of a preset sleep mode according to an embodiment of the present invention;

FIG. 4 is a flowchart illustrating a control procedure of suspending the execution of a preset sleep mode during recording of broadcasting according to an embodiment of the present invention;

FIGS. 5a to 5f are views illustrating a first example of presetting a sleep mode in a DMB terminal according to an embodiment of the present invention; and

FIG. 6a to 6e are views illustrating a second example of presetting a sleep mode in a DMB terminal according to an embodiment of the present invention.

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention rather unclear.

According to an exemplary embodiment of the invention, a sleep mode reservation function according to an exemplary embodiment of the invention is implemented in a digital multimedia broadcasting (DMB) terminal in such a manner that the sleep mode reservation function can be executed according to the execution status of other predetermined functions even though a preset sleep mode execution time arrives. A DMB terminal (or DMB device), as referred to throughout the disclosure, may be any terminal for receiving digital multimedia broadcast service including but not limited to a mobile telephone, PDA, and computer. To this end, according to an exemplary embodiment of the present invention, if a user inputs an input corresponding to the timing of the sleep mode execution time, a determination may made as to whether the sleep mode execution time arrives by driving a timer.

After determining that the sleep mode execution time arrives, a determination may be made whether there are other predetermined functions in execution. If it is determined that there are other predetermined functions in execution, the preset sleep mode execution may be suspended until corresponding predetermined functions in execution have been completed. After the completion of the predetermined functions, the preset sleep mode operation is performed. The execution of the sleep mode may include one or both of (1) cutting off power supplied to a module for performing the DMB service, and (2) terminating the DMB service.

Thus, it is possible to prevent the reset or the sudden stop of other predetermined functions such as the interruption of broadcasting recording when power to the broadcasting module is cut off due to the execution of the preset sleep mode.

In addition, according to an exemplary embodiment of the present invention, when a digital multimedia broadcasting service is terminated/paused (e.g., lack of reception by the DMB terminal of a digital multimedia broadcasting service) independently of the preset sleep mode operation, the setting of sleep mode may be maintained as ‘ON.’ If the digital multimedia broadcasting service is resumed before the expiration of the set sleep mode time, the preset sleep mode may be executed at the set time by keeping track of the time during the period that the broadcasting service is posed.

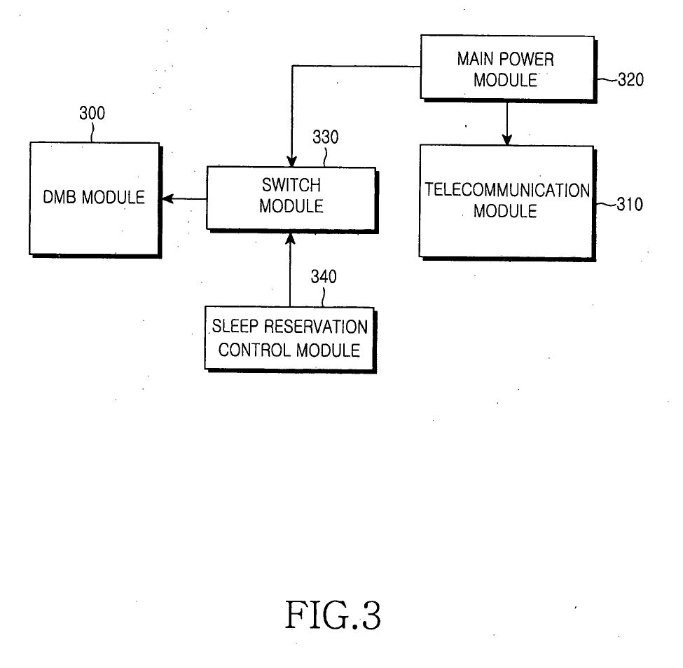

Hereinafter, components and operations of the digital multimedia broadcasting device performing the above-described function according to an exemplary embodiment of the invention will be described with reference to FIG. 3. FIG. 3 is a block diagram illustrating the internal structure of a digital multimedia broadcasting device capable of suspending the execution of a preset sleep mode according to an embodiment of the present invention.

The digital multimedia broadcasting device according to an embodiment of the present invention includes a DMB module 300, a telecommunication module 310, a main power module 320, a switch module 330, and a sleep reservation control module 340. The DMB module 300 may include components to perform the conventional DMB service. The telecommunication module 310 may include components to perform a conventional telecommunication service in a typical mobile device. Since operations of components of each of the modules 300 and 310 are generally known to those skilled in the art, detailed description about the operations is omitted in order to avoid redundancy.

The telecommunication module 310 according to an exemplary embodiment of the invention receives power from the main power module 320 and performs a conventional telecommunication service including wireless communication or data processing in a digital multimedia broadcasting device. In addition, the DMB module 300 receives power from the main power module 320 and performs a typical DMB service. The main power module 320 is connected to a battery of the digital multimedia broadcasting device. In this case, the DMB module 300 may directly receive power from the main power module 320 through the switch module 330. Also, the digital multimedia broadcasting device may be implemented in such a manner that the DMB module 300 indirectly receives through the telecommunication module 310. In addition, the digital multimedia broadcasting device may be implemented in such a manner that only power supplied to one of the DMB module 300 and the telecommunication module 310 may be cut off in order to prevent the halt of all functions of the module even though power is cut off due to the execution of the preset sleep mode.

In particular, FIG. 3 illustrates an exemplary embodiment of the invention in which each component is implemented in such a manner that only power supplied to the DMB module 300 from the main power module 320 may be cut off when a preset sleep mode is performed. The switch module is provided between the main power module 320 and the DMB module 300 to control the power supply connection, and the switch module 330 is controlled by the sleep reservation control module 340. The sleep reservation control module 340 may be implemented as a component separated from the telecommunication module 310 as shown in FIG. 3, or as a component included in the telecommunication module 310. The sleep reservation control module 340 may be implemented outside the DMB module 300 so that the execution of the preset sleep mode can be individually performed even though a DMB service is terminated and the power to the DMB module 300 is cut off. The sleep reservation control module 340 drives a timer so as to determine if the preset sleep mode execution time arrives.

If the preset sleep mode execution time arrives, the sleep reservation control module 340 according to an exemplary embodiment of the present invention cuts off power to the DMB module 300 by controlling the switch module 330 so as to terminate a DMB service. In this case, according to an embodiment of the present invention, if there is one or more predetermined functions which are currently performed relating to the DMB module 300, the sleep reservation control module 340 waits for the completion of the corresponding functions and then terminates the DMB service after the functions are completely terminated. For example, if a broadcasting recording function is being still performed when the preset sleep mode execution time arrives, the sleep reservation control module 340 waits for the completion of recording and then terminates the DMB service.

Hereinafter, an exemplary embodiment of the present invention where a DMB service is paused (e.g., by lack of DMB service reception) or a user terminates and then resumes a DMB service during the period of determining whether a preset sleep mode execution time arrives will be described. Even though the DMB service is terminated and then resumed (e.g., due to user termination or lack or DMB service reception), the sleep reservation control module 340 continues to drive a timer and determine if the preset sleep mode execution time arrives in such a manner that the setting of sleep mode can be maintained as ‘ON’ regardless of the operation (e.g., the DMB module may be turned off by cutting off its power to save power) of the DMB module 300. In other words, even when the DMB service is terminated (e.g., due to a vacancy in the DMB service), the sleep reservation control module 340 continues to count the time in order to prohibit the reset of sleep mode setting to ‘OFF’.

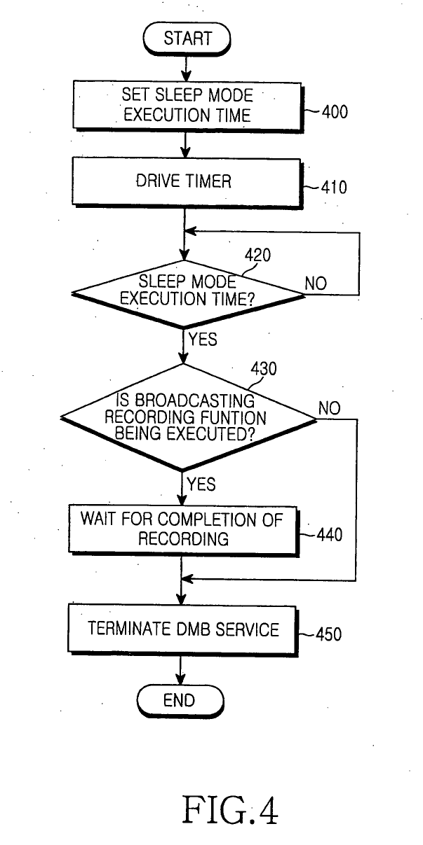

Hereinafter, a procedure of suspending the execution of a preset sleep mode in a digital multimedia broadcasting device having the above described function will be described with reference to FIG. 4. FIG. 4 is a flowchart illustrating a control procedure of suspending the execution of a preset sleep mode during recording of broadcasting according to an embodiment of the present invention.

If a user sets a sleep mode execution time in step 400, the sleep reservation control module 340 drives a timer in order to determine if the set sleep mode execution time arrives in step 410. The set sleep mode execution time is stored in a non-volatile block of a memory implemented in the telecommunication module 310 by employing a file or a database.

In step 420, the sleep reservation control module 340 determines if the preset sleep mode execution time arrives. When functions in execution must be terminated in order to perform a preset sleep mode due to the arrival of the preset sleep mode execution time, the sleep reservation control module 340 determines if there are predetermined functions in execution. For example, when a broadcasting recording function among various functions executed relating to the DMB module 300 is being executed, the sleep reservation control module 340 determines if the broadcasting recording function is being executed in step 430. If the broadcasting recording function is being executed, the sleep reservation control module 340 waits for the completion of the broadcasting recording function in step 440 and then terminates the DMB service in step 450 after the completion of the broadcasting recording function.

Although the broadcasting recording function among predetermined functions relating to the digital multimedia broadcasting service is described above, the method for suspending the execution of the preset sleep mode may be applied when a user is executing predetermined functions other than the broadcasting recording function, such as a function of re-viewing broadcasting stored by the user and a function of inputting an expected time of reservation recording. In other words, the above-described various predetermined functions relating to the digital multimedia broadcasting service may serve as factors for suspending the power-off to the DMB module 300 in the device caused by the execution of the preset sleep mode.

According to another embodiment of the present invention, if a DMB service is terminated (e.g., by a user termination or lack of DMB service reception), the sleep reservation control module 340 continuously counts time by driving a timer continuously in order to determine if the preset sleep mode execution time arrives. The power to the DMB module may be cut off while the DMB service is terminated. Accordingly, when the DMB service is resumed while counting the remaining time, the remaining time from the resumption is counted and then the DMB service is terminated after the remaining time. When the DMB service is resumed (e.g., by the user or by the DMB service reception being resumed), if there is a remaining time until the input sleep mode execution time, the DMB module 300 receives power again and provides a digital multimedia broadcasting service according to the service connection.

According to an exemplary embodiment of the invention, when the digital multimedia broadcasting device is powered off, the sleep reservation control module 340 may store the last counted time on a non-volatile memory at the time that the device is turned off. Accordingly, when the multimedia broadcasting device is turned on, the sleep reservation control module 340 drives a timer again based on the stored, last counted time—the timer is also turned off when the DMB terminal is turned off. Therefore, the sleep reservation control module 340 counts again up to the preset sleep mode execution time for the preset sleep mode based on the stored, last counted time.

Then, if a predetermined time arrives, the sleep reservation control module 340 determines the suspension of the execution of the preset sleep mode through the above-described scheme according to an activation state of other predetermined functions in execution. If the predetermined functions in execution are completely terminated, the sleep reservation control module 340 performs the preset sleep mode so as to cut off the power supplied to the DMB module 300. Then, if an operation in the DMB module 300 is terminated by cutting off the power supplied through the switch module 330, the DMB service is terminated.

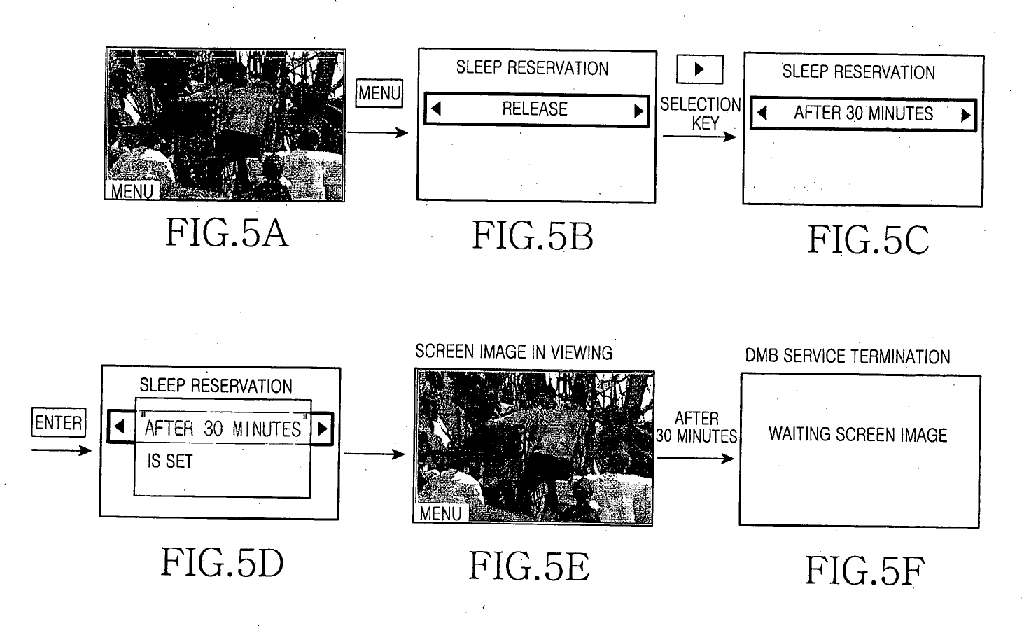

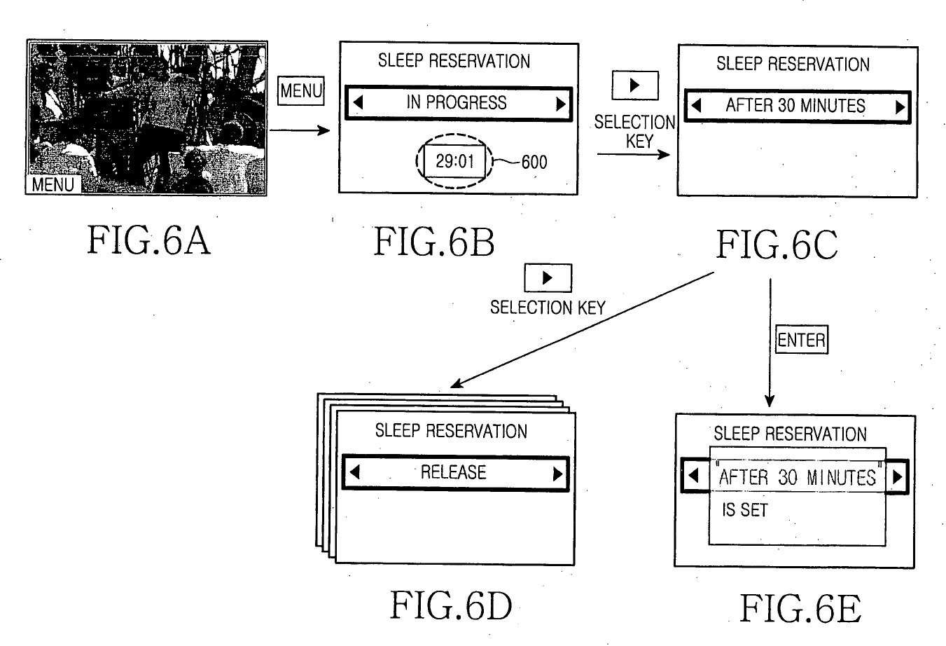

Hereinafter, exemplary embodiments of the present invention will be described in detail with reference to FIGS. 5a to 6e. FIGS. 5a to 5f illustrate a first example for presetting a sleep mode in a digital multimedia broadcasting device according to an exemplary embodiment of the present invention, and FIGS. 6a to 6e illustrate a second example for presetting a sleep mode in a digital multimedia broadcasting device according to an exemplary embodiment of the present invention.

Referring to FIGS. 5a to 5f, FIG. 5 a is a view illustrating an example of displaying broadcasting according to a DMB service and that a menu function is additionally provided in the broadcasting screen image such that a user can preset a sleep mode.

In addition, FIGS. 5a and 5c illustrate a case where a user a sleep mode reservation function while viewing broadcasting and a case where the user selects menu so as to select the sleep mode reservation function item. FIG. 5b and FIG. 5c illustrate that items such as “release”, “after 30 minutes”, “after 60 minutes”, “after 90 minutes”, “after 120 minutes”, “after 150 minutes”, and “after 180 minutes” are provided as sub items for the sleep mode reservation function item. As described above, the preset sleep mode execution time denotes time to perform a sleep mode which is the mode of terminating the digital multimedia broadcasting service after a predetermined time interval.

In addition, a directional key is used as a selection key as shown in FIGS. 5b and 5c, thereby enabling movement between sub items. If the direction key is input by a user in a state where the “release” item is displayed as shown in FIG. 5b, another sub-item is displayed. If the user inputs an “Enter key” in a state where the “after 30 minutes” item is displayed, the preset sleep mode execution time is set as shown in FIG. 5d. It is possible to make a preset sleep time to be, for example, 30 minutes from a current time. In addition, as shown in FIG. 5d, if another key is not input by the user in a state where a message reporting that a sleep mode reservation function is set is displayed, a screen image for the sleep mode reservation function is terminated and a broadcasting image shown in FIG. 5e is returned. Then, after 30 minutes elapses from the above-mentioned current time (i.e., when the preset sleep time arrives), the DMB service is terminated and then a predetermined image may be displayed as shown in FIG. 5f.

FIGS. 6a to 6e illustrate an exemplary embodiment of the invention where a sleep mode reservation function is selected when the sleep mode reservation function has been already set. FIG. 6a illustrates that a menu function is additionally provided on a broadcasting screen image such that a user can set a sleep mode reservation function as shown in FIG. 5a. Accordingly, since the sleep mode reservation function has been already executed when the menu function is selected, an “in progress” message reporting that the sleep mode reservation function is being executed may be displayed in FIG. 6b. In addition, as indicated through reference numeral 600, a remaining time up to the preset sleep mode execution time may be displayed. In this case, as shown in FIG. 6c, the user can change the preset sleep mode execution time by using a directional key as a selection key. Accordingly, if the “release” item is selected through pressing of the direction key by the user in FIG. 6c, a screen image shown in FIG. 6d is displayed. In this state, if the “enter” key is input, the sleep mode reservation function is released. In addition, if the user presses the “enter” key in a state where the “after 30 minutes” item is displayed as shown in FIG. 6c, a message reporting that a preset sleep mode execution time is set is displayed during a predetermined time interval as shown in FIG. 6e and then the display returns to broadcasting service image. As described above, if the preset sleep mode execution time is changed, a remaining time count for the previous preset sleep mode execution time is deleted.

Although menu items are moved and selected using the directional key and the enter key as described above, a sleep mode reservation function according to an exemplary embodiment of the present invention is not provided only by means of a key pad, but may be provided by means of a touch screen. In addition, although FIGS. 5f and 6e illustrate examples of sub-items for setting the sleep mode reservation function and sub-items in a state in which the sleep mode reservation function is set, these are only examples, and the contents according to an exemplary embodiment of the present invention are not limited to these examples. In other words, it is possible to make various sub-items and various screen images according to the selection of users, service providers, and device manufacturing companies.

As described above, according to an exemplary embodiment of the invention, when a sleep mode reservation function is performed while a user is using other predetermined functions such as a recording function, a re-viewing function, and a reservation recording setting function in a digital multimedia broadcasting device, the execution of the preset sleep mode is suspended until other predetermined functions in execution relating to digital multimedia broadcasting (e.g., function other than the typical broadcasting function such as outputting the broadcasting service to LCD or a speaker) are finished and then executed. It is possible to prevent unintended sudden stop of other predetermined functions in execution

While the invention has been shown and described with reference to certain preferred embodiments thereof, it will be understood by those skilled in the art that various changes in form and details may be made therein without departing from the spirit and scope of the invention.

What is claimed is:

1. A method comprising the steps of:
presetting a sleep mode of a digital multimedia broadcasting (DMB) terminal in response to a timing input from a user as to when the sleep mode is to be executed;
detecting the arrival of the sleep mode execution time;
after detecting the arrival of the sleep mode execution time, determining whether a predetermined function relating to a DMB service is being executed;
suspending the execution of the sleep mode until the predetermined function is completed; and
executing the sleep mode after the completion of the predetermined function.

2. The method as claimed in claim 1, wherein the timing input is a time duration after which the sleep mode is to be executed.

3. The method as claimed in claim 1, wherein the predetermined function is a recordation of a DMB service.

4. The method as claimed in claim 1, wherein the step of executing the sleep mode includes a step of cutting off power supplied to a module for performing the DMB service.

5. The method as claimed in claim 1, wherein the step of executing the sleep mode includes a step of terminating the DMB service.

6. The method as claimed in claim 1, further comprising the step of:
continuously counting, after the DMB service is terminated independently of the presetting of the sleep mode, a time remaining for the arrival of the sleep mode execution time; and
supplying, when the DMB service is resumed after the independent termination but before the expiration of the remaining time, power to a module for performing the DMB service

7. The method as claimed in claim 6, wherein the step of executing the sleep mode terminates the DMB service after passing the remaining time after the resumption of the DMB service.

8. The method as claimed in claim 1, further comprising the steps of:
storing, in a non-volatile memory block, a finally counted time of a timer when the DMB terminal is powered off; and
resuming the counter from the finally counted time when the DMB terminal is powered on.

9. The method as claimed in claim 1, wherein the predetermined function is either a re-viewing or a reservation setting for recording.

10. A digital multimedia broadcasting (DMB) terminal comprising:
a first module to supply power; and
a second module, after presetting of a sleep mode of the DMB terminal in response to a timing input from a user as to when the sleep mode is to be executed, to:
detect the arrival of the sleep mode execution time;
after detecting the arrival of the sleep mode execution time, determine whether a predetermined function relating to a DMB service is being executed;
suspend the execution of the sleep mode until the predetermined function is completed; and
execute the sleep mode after the completion of the predetermined function, wherein the first module supply power to the second module.

11. The DMB terminal as claimed in claim 10, wherein the timing input is a time duration after which the sleep mode is to be executed.

12. The DMB terminal as claimed in claim 10, wherein the predetermined function is a recordation of a DMB service.

13. The DMB terminal as claimed in claim 10, the execution of the sleep mode includes cutting off power supplied to a module for performing the DMB service.

14. The DMB terminal as claimed in claim 10, wherein the execution of the sleep mode includes terminating the DMB service.

15. The DMB terminal as claimed in claim 10, wherein the second module is adapted to:
continuously count, after the DMB service is terminated independently of the presetting of the sleep mode, a time remaining for the arrival of the sleep mode execution time; and
control to supply, when the DMB service is resumed after the independent termination but before the expiration of the remaining time, power to a module for performing the DMB service

16. The DMB terminal as claimed in claim 15, wherein the execution of the sleep mode terminates the DMB service after passing the remaining time after the resumption of the DMB service.

17. The DMB terminal as claimed in claim 10, wherein the second module is adapted to:
store, in a non-volatile memory block, a finally counted time of a timer when the DMB terminal is powered off; and
resume the counter from the finally counted time when the DMB terminal is powered on.

18. The DMB terminal as claimed in claim 10, wherein the predetermined function is either a re-viewing or a reservation setting for recording.
